(19) United States
(12) Patent Application Publication
(10) Pub. No.: US 2026/0277465 A1
(43) Pub. Date: Sep. 17, 2026

(54) BYTE STREAM PROCESSING PIPELINE FOR A HARDWARE INTEGRATED CIRCUIT

(71) Applicant: Google LLC, Mountain View, CA (US)

(72) Inventors: Hongil Yoon, San Jose, CA (US); Anand Suresh Kane, Santa Clara, CA (US); Xiaoxiao Long, San Jose, CA (US)

(21) Appl. No.: 19/167,983

(22) PCT Filed: Mar. 25, 2024
(86) PCT No.: PCT/US2024/021301

§ 371 Date: Sep. 23, 2025

Related U.S. Application Data
(60) Provisional application No. 63/492,181, filed on Mar. 24, 2023.

(51) Int. Cl. G06F 3/06

(52) U.S. Cl. CPC G06F 3/0655; G06F 3/0604; G06F 3/0679

(57) ABSTRACT

Methods and systems, including computer-readable media, are described for a byte stream processing pipeline using an instruction set architecture for a hardware integrated circuit. The byte stream pipeline is used to access memory banks of a compute tile of the circuit based on an instruction executed at the tile. An opcode is identified in the instruction. The opcode indicates an operation to access memory banks of a memory at the tile. From the opcode, a byte addressing sequence is generated to access different lengths of contiguous bytes that are stored at the banks. Based on the byte addressing sequence, multiple byte-addressable memory accesses are performed at the memory to obtain a plurality of input vectors from the memory banks.

### BACKGROUND

This specification generally relates to memory operations of a hardware integrated circuit.

Neural networks are machine-learning models that employ one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing. Different types of neural network architectures can be used to perform a variety of tasks related to classification or pattern recognition, predictions that involve data modeling, and information clustering.

A neural network layer can have a corresponding set of parameters or weights. The weights are used to process inputs (e.g., a batch of inputs) through the neural network layer to generate a corresponding output of the layer for computing a neural network inference. A batch of inputs and a set of kernels can be represented as a tensor, i.e., a multi-dimensional array, of inputs and weights, respectively. A hardware accelerator is a special-purpose integrated circuit for implementing neural networks. The circuit includes memory with locations corresponding to elements of a tensor that may be traversed or accessed using control logic of the circuit.

### SUMMARY

This document describes aspects of an enhanced instruction set that is executable by a processor or hardware accelerator to provide efficient byte-level data streaming processes. The disclosed techniques and instruction set also allow for corresponding synchronization of those streaming processes for a variety of compute intensive operations, including a variety of machine-learning (ML) workloads for inference or prediction operations.

One aspect of the subject matter described in this specification can be embodied in a computer-implemented method for accessing memory banks of a hardware accelerator.

The method includes receiving an instruction for a compute tile of the hardware accelerator. The instruction is executable at the compute tile to cause performance of operations that include: i) identifying, in the instruction, an opcode for an operation that involves accessing one or more banks of a first memory of the compute tile; ii) generating, based on the opcode, a byte addressing sequence used to access different lengths of contiguous bytes stored at the one or more banks; iii) based on the byte addressing sequence, performing, at the first memory, multiple byte-addressable memory accesses to obtain multiple input vectors from the one or more banks of the first memory; and iv) processing, based on the instruction, each of multiple input vectors at the hardware accelerator.

These and other implementations can each optionally include one or more of the following features. For example, in some implementations, the byte addressing sequence is operable to access the different lengths of contiguous bytes starting from any given byte address across the one or more banks of the first memory. The method includes generating, based on the opcode, a byte access request that provides byte-granularity access for obtaining at least one byte of data stored at a given row of a bank among the one or more banks of the first memory.

In some implementations, generating the byte addressing sequence includes: generating a byte addressing sequence corresponding to multiple byte access requests, each byte access request being used to access distinct/different portions of byte-level data stored at respective address locations across the one or more banks of the first memory. In some cases, each byte access request can be used to access a respective distinct portion of byte-level data stored at a respective address location. The opcode can be for a tensor operation that is executed at the compute tile to traverse respective elements of an input tensor.

In some implementations, the method further includes: i) executing the multiple byte access requests using the byte addressing sequence; ii) performing multiple byte-granularity accesses at the first memory based on the multiple byte access requests that are executed; and iii) traversing respective elements of the input tensor by performing the multiple byte-granularity accesses at the first memory. In some implementations, each distinct portion of byte-level data that is stored at a respective address location across the one or more banks of the first memory corresponds to a respective element of the input tensor; and each respective address location that stores a distinct portion of byte-level data is mapped to a corresponding element of the input tensor.

In some implementations, a portion of byte-level data corresponds to an input vector of the multiple input vectors; and the multiple byte-addressable memory accesses that are used to obtain multiple input vectors correspond to at least one of: i) the multiple byte-granularity accesses and ii) the multiple byte access requests. In some aspects, processing the multiple input vectors includes: processing the multiple input vectors through a neural network layer of a neural network implemented at the hardware accelerator; and generating an output for the neural network layer in response to processing the multiple input vectors through the neural network layer.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages.

Unlike prior methods for data access that were limited to row addressing schemes for accessing physical memory, the disclosed techniques provide an Instruction Set Architecture (ISA) that allows for enhanced byte-level addressing functions for a memory, such as an on-chip static random access memory (SRAM) of an example special-purpose integrated circuit, e.g., a hardware accelerator, a graphics processing unit (GPU), or a neural network (NN) processor, including a tensor processing unit (TPU) or vector processing unit (VPU). The special-purpose integrated circuit can also be a hardware accelerator or neural net processor that uses a particular type of memory structure to store inputs for a ML workload.

Existing ISAs have data padding and access alignment requirements, and can be difficult to program and debug. In contrast, byte addressing provided by the improved instruction set of this document enables localized access to various lengths of contiguous bytes from any given byte address of an input memory of a compute tile. The techniques and systems disclosed in this specification can provide for new combinations of byte access patterns in support of ML computations. Such data access patterns allow for various types of fine grained stride operations for ML image processing operations, as well as spatial and temporal data reuse in support of ML inference and training workloads for a range of data science applications.

The improved ISA includes one or more “ByteAddressingMode” instructions with integrated fields that allow for auto-zero padding when accessing data from an input memory of a compute tile. For example, based on the disclosed instruction set, a processor of a compute tile can issue a byte access request providing byte-granularity access for obtaining at least one byte of data stored at a given row of a physical memory bank among the one or more banks of the first memory. Thus, a single byte can be retrieved without requiring extraneous data padding, such as padding the request with another byte and requiring access alignment across a particular set of rows or banks.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system for implementing a neural network machine-learning model.

FIG. 2 shows an example processing pipeline for routing inputs and outputs between a memory and compute cells of a hardware integrated circuit.

FIG. 3 shows example fields and message structures of example instruction sets.

FIG. 4 shows code for an example byte-addressing operation of an instruction set.

FIG. 5 shows aspects of an example byte-addressing operation.

FIG. 6 is an example process for byte stream processing using an example byte-addressing operation of an instruction set.

FIG. 7 illustrates an example of an input tensor, a parameter tensor, and an output tensor.

Like reference numbers and designations in the various drawings indicate like elements.

### DETAILED DESCRIPTION

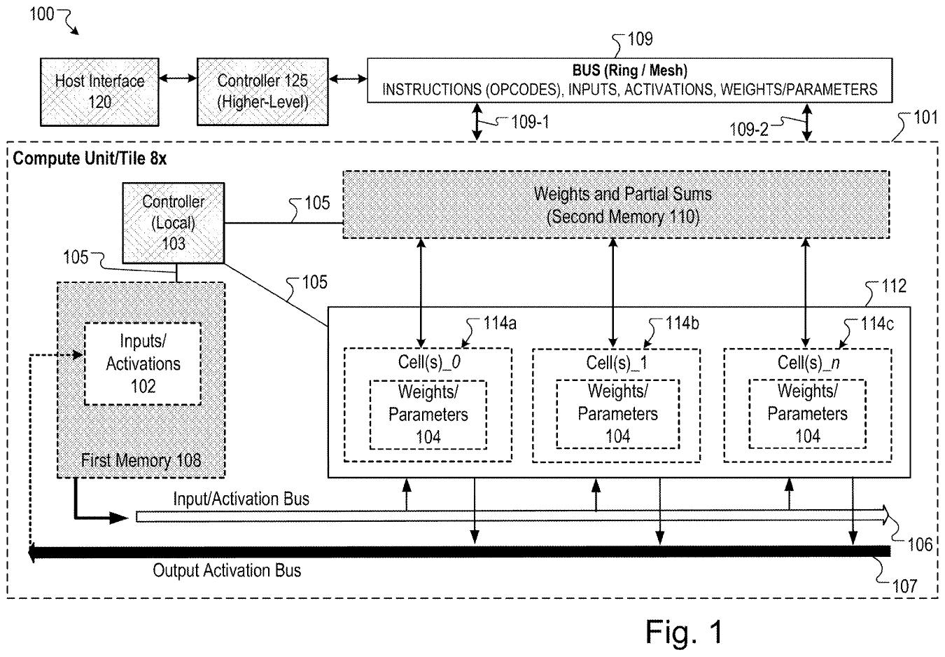

FIG. 1 is a block diagram of an example computing system 100 for implementing a neural network model at a hardware integrated circuit, such as a machine-learning hardware accelerator. Compute system 100 includes one or more compute tiles 101, a host 120, and a higher-level controller 125 (“controller 125”). As described in more detail below, the host 120 and controller 125 cooperate to provide datasets and instructions to one or more compute tiles 101 of system 100.

In some implementations, the host 120 and the controller 125 are the same device. The host 120 and the controller 125 can also perform distinct functions but be integrated in a single device package. For example, the host 120 and controller 125 can form a central processing unit (CPU) that interacts or cooperates with a hardware accelerator having the multiple compute tiles 101. In some implementations, the host 120, controller 125, and multiple compute tiles 101 are included or formed as different sections on a single integrated circuit die. For example, the host 120, controller 125, and multiple compute tiles 101 can form a special-purpose System-on-Chip (SoC) that is optimized for executing neural network models for processing machine-learning workloads.

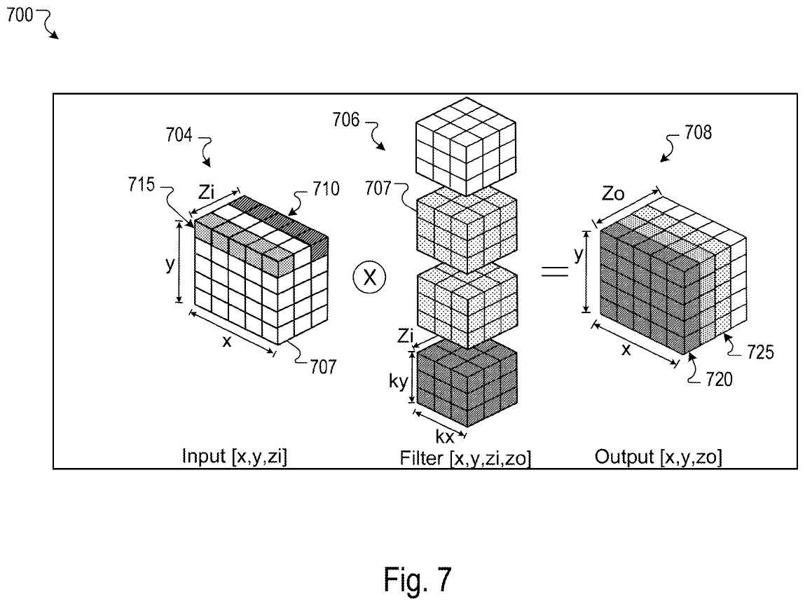

Each compute tile 101 generally includes a controller 103 that provides one or more control signals 105 to cause inputs (or activations) for an input vector 102 to be stored at, or accessed from, a memory location of a first memory 108 (“memory 108”). Likewise, the controller 103 can also provide one or more control signals 105 to cause weights (or parameters) for a matrix structure of weights 104 to be stored at, or accessed from, a memory location of a second memory 110 (“memory 110”). In some examples, the memory 108 is identified as a “narrow,” whereas memory 110 is identified as “wide.” In some implementations, the input vector 102 is obtained from an input tensor, whereas the matrix structure of weights is obtained from a parameter tensor. Each of the input tensor and the parameter tensor may be multi-dimensional data structures, such as a multi-dimensional matrix or tensor. This is described in more detail below with reference to FIG. 7.

Each memory location of memory 108, 110 may be identified by a corresponding memory address, such as a logical address that has a corresponding mapping to a physical row of a physical memory bank of the memory. A compute tile 101 may derive a set of contiguous addresses (e.g., virtual/logical addresses) from a group of requests. For example, the set of contiguous addresses can be derived with reference to a logical memory that corresponds to the physical memory 108 of the compute tile 101.

The logical memory can have multiple logical ports and each port can be connected to, or associated with, a different requestor that requests to access physical resources of the memory 108. To process a given access request, for each port, the tile 101 (or its controller 103) determines a bank to which the request will be routed based on an address in that request.

For each bank, the compute tile 101 can include an arbiter that arbitrates access from the multiple ports to that bank, for example, in accordance with a bank generation function that is uniquely configured to mitigate against some (or all) of the requests being routed to the same physical memory bank. The logical memory, ports of the logical memory, and the arbiters can be implemented in software, hardware, or both. In some implementations, the logical memory and its ports as well as the arbiters are controlled based on control signals generated by the controller 103.

Each of memory 108, 110 can be implemented as a series of physical banks, units, or any other related storage medium or device. Each of memory 108, 110 can include one or more registers, buffers, or both. In some implementations, memory 108 is an input/activation memory, whereas memory 110 is a parameter memory. In some other implementations, inputs or activations are stored at memory 108, memory 110, or both: and weights are stored at memory 110, memory 108, or both. For example, inputs and weights may be transferred between memory 108 and memory 110 to facilitate certain neural network computations. In some implementations, each of memory 108 and memory 110 are referred to as tile memory.

Each compute tile 101 also includes an input activation bus 106, an output activation bus 107, and a computational unit 112 that includes one or more hardware multiply accumulate circuits (MACs) in each cell 114 a/b/c. Controller 103 can generate control signals 105 to obtain operands stored at the memory of the compute tile 101. For example, controller 103 can generate control signals 105 to obtain: i) an example input vector 102 stored at memory 108 and ii) weights 104 stored at memory 110. Each input obtained from memory 108 is provided to input activation bus 106 for routing (e.g., direct routing) to a compute cell 114 a/b/c in the computational unit 112. Similarly, each weight obtained from memory 110 is routed to a cell 114 a/b/c of the computational unit 112.

As described below, each cell 114 a/b/c performs computations that produce partial sums or accumulated values for generating outputs for a given neural network layer.

An activation function may be applied to a set of outputs to generate a set of output activations for the neural network layer. In some implementations, the outputs or output activations are routed for storage and/or transfer via output activation bus 107. For example, a set of output activations can be transferred from a first compute tile 101 to a second, different compute tile 101 for processing at the second compute tile 101 as input activations for a different layer of the neural network.

In general, each compute tile 101 and system 100 can include additional hardware structures to perform computations associated with multi-dimensional data structures such as tensors, matrices and/or data arrays. In some implementations, inputs for an input vector (or tensor) 102 and weights 104 for a parameter tensor can be pre-loaded into memory 108, 110 of the compute tile 101. The inputs and weights are received as sets of data values that arrive at a particular compute tile 101 from a host 120 (e.g., an external host), via a host interface, or from a higher-level control such as controller 125.

Each of compute tile 101 and controller 103 can include one or more processors, processing devices, and various types of memory. In some implementations, processors of compute tile 101 and controller 103 include one or more devices, such as microprocessors or central processing units (CPUs), graphics processing units (GPUs), application specific integrated circuits (ASICs), or a combination of different processors. Each of compute tile 101 and controller 103 can also include other computing and storage resources, such as buffers, registers, control circuitry, etc. These resources cooperate to provide additional processing options for performing one or more of the determinations and calculations described in this specification.

In some implementations, processing unit(s) of controller 103 executes programmed instructions stored in memory to cause controller 103 and compute tile 101 to perform one or more functions described in this specification. The memory of controller 103 can include one or more non-transitory machine-readable storage mediums. The non-transitory machine-readable storage medium can include solid-state memory, a random access memory (RAM), a read-only memory (ROM), an erasable programmable read-only memory (e.g., EPROM, EEPROM, or Flash memory), or any other tangible medium capable of storing information or instructions.

The system 100 receives instructions that define a particular compute operation to be performed by a compute tile 101. The system 100 also receives data such as inputs, activations, weights (or parameters) that are operands for the compute operation. The system 100 can include one or more buses 109 that are used for routing the instructions and data.

For example, the system 100 can include a first bus 109-1 that provides instructions, including related commands, opcodes, and operational parameters (not weights), to each of the one or more compute tiles 101 of the system 100. The system 100 can also include a second bus 109-2 that provides data or operands to each of the one or more compute tiles 101 of the system 100.

The buses 109 can be configured to provide one or more inter-connected data communication paths between two or more compute tiles of system 100. For example, the first bus 109-1 can be a ring bus that traverses each compute tile to communicate datasets and a single instruction (or multiple instructions) to one or more compute tiles to execute an ML workload, whereas the second bus 109-2 can be a mesh bus that interconnects two or more tiles to provide data or sets of operands between two or more compute tiles 101.

In some implementations, bus 109-1 and bus 109-2 are distinct data buses. In some other implementations, bus 109-1 and bus 109-2 are the same data bus. In some cases, to process an example workload, a first compute tile 101 arbitrates and executes access requests (e.g., read/write requests) for memory 108, where the requests are based on external data communications that originate from outside the first compute tile 101, such as from a second, different compute tile 101. Such external communications may be received at the first tile 101 via bus 109-2 (e.g., a mesh bus).

Each compute tile 101 is an individual computing unit that cooperates with other tiles 101 in the system 100 to accelerate computations across one or more layers of a multi-layer neural network or across one or more sections of another machine-learning construct.

Each compute tile 101 can function as an individual computing unit. For example, each compute tile 101 is a self-contained computational component that is configured to execute a subset of tensor or ML computations independently relative to other compute tiles. In some implementations, compute tiles 101 can also share execution of tensor computations associated with a given instruction.

In some implementations, a host can generate sets of parameters (i.e., weights) and corresponding inputs for processing at a neural network layer. For example, a host can generate sets of compressed parameters (CSP) and corresponding mapping vectors, e.g., a non-zero map (NZM), that map an neural network input to a non-zero parameter in a set of CSPs for a given operation. The host 120 can send, via a host interface, the parameters to a compute tile 101 for further processing at the tile. The controller 103 can execute programmed instructions to analyze a data stream associated with the received weights and inputs, including the compressed parameters and corresponding mapping vectors.

The controller 103 causes inputs and weights of the data stream to be stored at the compute tile 101. For example, the controller 103 can store the inputs, including any associated mapping vectors, and weights/parameters, including any associated compressed sparse parameters, in the local tile memory of the compute tile 101. This is described in more detail below. The controller 103 can also analyze the input data stream to detect an operation code (“opcode”). The system 100 can support various types of opcodes, such as opcode types that indicate operations for vector-matrix Multiplication, elementwise vector operation and whether a given operation will use compressed sparse parameters/weights vs uncompressed parameters/weights.

Based on one or more opcodes, the controller 103 can activate or execute a bank generation function to arbitrate requests for access to tile memory of a compute tile 101. For example, the controller 103 leverages the bank generation function to arbitrate two or more requests such that each of the two or more requests are processed against different physical banks of the tile memory. The controller 103 can employ a predetermined bank selection technique that is programmed or encoded at the controller 103 before inference determinations are performed at the compute tile 101.

In some implementations, a given compute operation involves multiple requesters that each require access to resources of the memory 108. For example, a computational workload performed at compute tile 101 can trigger memory access requests due to tensor traversal operations that require read and write access to respective address locations of memory 108. The system 100 can use the enhanced byte-level addressing functions of the disclosed ISA to process these requests to access one or more bytes of data stored at address locations of memory 108, 110. As described below, these address locations can correspond to elements of an input (or parameter/weight) tensor that is processed as part of the workload.

In addition to the tensor read/write operations, processing the workload can also involve processing read or write access requests to: i) move data (e.g., parameters) from memory 108 (e.g., a first on-chip SRAM) to memory 110 (e.g., a second on-chip SRAM) and ii) move data from memory 110 to memory 108. Tensor operations (tensorops) can be indicated by an opcode in an instruction (e.g., a single instruction) received at a compute tile 101. For example, a “ByteAddressingMode” instruction can include one or more opcodes for a tensor operation that is executed at the compute tile 101 to traverse respective elements of an input tensor. In general, tensor operations can be performed to execute a particular ML compute operation that involves: i) consuming (or reading) tensors from memory 108, 110 and ii) producing (or writing) tensors to memory 108, 110.

As used in this document, the first on-chip SRAM may refer to one or more memory units that each operate on and store data having a size (or width) that is equal to or less than, for example, 16-bits, 32-bits, or 64-bits, whereas the second on-chip SRAM may refer to one or more memory units that each operate on and store data having a size (or width) that is greater than 64-bits or the data size operated on by the first SRAM units. For example, a size or width for the on-chip SRAM 108 can be between 8-bits and 64-bits, whereas a size or width for an on-chip SRAM 110 can be between 64-bits and 256-bits. Of course, other sizes and data widths that exceed these example ranges are also contemplated for each of memory 108, memory 110.

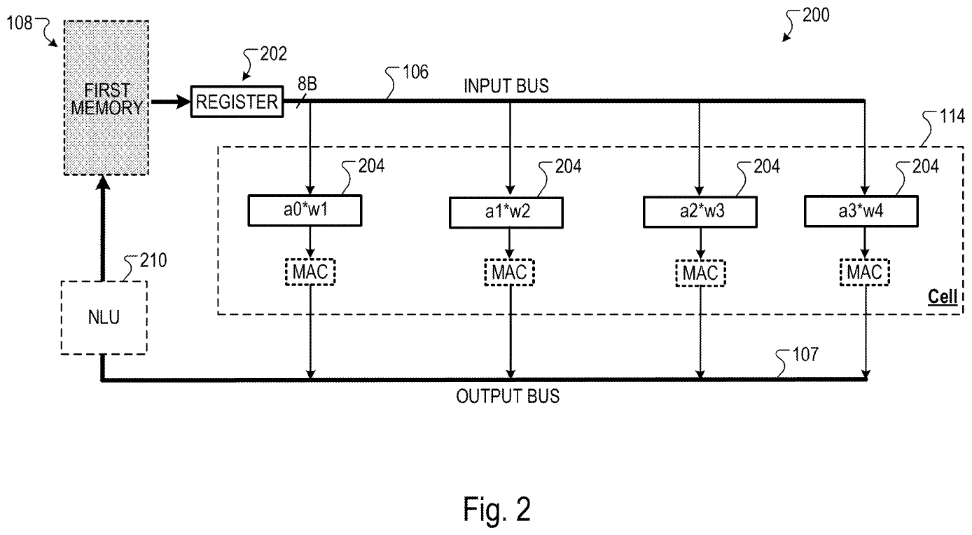

FIG. 2 shows an example processing pipeline for routing inputs and outputs between a memory and compute cells of a hardware integrated circuit. In general, pipeline 200 uses the input bus 106 to route inputs obtained from a memory location of memory 108 to one or more compute cells 114. In some implementations, the inputs that are routed to a compute cell 114 via input bus 106 are inputs that are obtained from memory 108 using various combinations of byte access requests that are based on the byte-level addressing functions of the enhanced ISA disclosed in this specification.

The pipeline 200 uses the output bus 107 to route outputs to memory locations of memory 108. These outputs can be numerical or quantitative outputs generated from computational operations (e.g., multiplication or other arithmetic) performed at the one or more compute cells 114. Each tile 101 can include a non-linear unit (NLU) 210 that applies a non-linear activation function to outputs that are results of arithmetic performed at the computational unit 112. For example, the compute tile 101 causes the NLU 210 to apply the activation function (e.g., sigmoid, tanh) to generate output activations for computations at a given neural network layer. The pipeline 200 uses the output bus 107 to route outputs (or output activations) to memory locations of memory 108.

The pipeline 200 leverages a hardware architecture where the input bus 106 is coupled (e.g., directly coupled) to each of multiple groupings of hardware compute cells of a special-purpose integrated circuit. Although memory 110 is not shown in the example of FIG. 2, the system 100 can provide a first operand from a location in memory 108 and a second operand from a location in memory 110, which is described above with reference to FIG. 1.

The operands 204 are used in computations performed at the cell 114 and cell 114 generates an output corresponding to a result of the computation. In some implementations, the computations are for a machine-learning operation, such as for processing inputs through a neural network layer of an artificial neural network.

In this implementation, a compute tile 101 can provide first operands corresponding to inputs or activations (e.g., a0, a1, a2, etc.) of an input feature map to a subset of cells 114. For example, a respective input of an input vector 102 is provided to each MAC in the subset via the input bus 106 of the compute tile 101 following a byte-level data access operation that is performed against a memory bank of memory 108. The system 100 can provide different respective sets of inputs based on byte-level access operations that are performed locally at one each compute tile.

The system 100 can process, execute, or otherwise perform different combinations of byte access requests to obtain or write sets of operands for a given compute operation. For example, across multiple compute tiles 101, the system 100 can perform broadcast operations to route groups of inputs (or operands) to cells 114 of a given tile. The system 100 can compute products for a given neural network layer using the respective groupings of inputs and corresponding weights at each compute tile 101. At a given compute tile 101, the products are computed by multiplying a respective input (e.g., a1) and corresponding weight (e.g., w1) at each MAC in the subset, using multiplication circuitry of the MAC.

The system 100 can generate an output for the layer based on an accumulation of multiple respective products that are computed at each MAC of a cell 114a/b/c in a subset of cells 114a/b/c of a compute unit 112. As explained below at least with reference to FIG. 7, the multiplication operations performed within a compute tile 101 can involve: i) a first operand (e.g., an input or activation) stored at a memory location of memory 108 that corresponds to a respective element of an input tensor and ii) a second operand (e.g., a weight) stored at a memory location of memory 110 that corresponds to a respective element of a parameter tensor.

In the example of FIG. 2, a shift register 202 can provide shift functionality such that an input of the operands 204 is broadcast onto the input bus 106 and routed to the one or more MACs of cell 114. In some implementations, the shift register 202 enables one or more input broadcast modes at a compute tile 101. For example, the shift register 202 can be used to broadcast inputs sequentially, e.g., one-by-one, from memory 108 (first broadcast mode), concurrently, e.g., in parallel, from memory 108 (second broadcast mode), or using some combination of these broadcast modes. The shift register 202 can be an integrated function of memory 108, and may be implemented in hardware, software, or both.

In some implementations, the weight (w3) of the operands 204 may have a weight value of zero. When the controller 103 determines that the weight (w3) has a zero value, to conserve processing resources, a multiplication between an input (a2) and the weight (w3) can be skipped, such that those operands are not routed to, or consumed by, a cell 114 a/b/c. The determination to skip that particular multiplication operation can be based on a mapping vector that maps discrete inputs (an) of an input vector to individual weights (wn) of a parameter tensor, as described above.

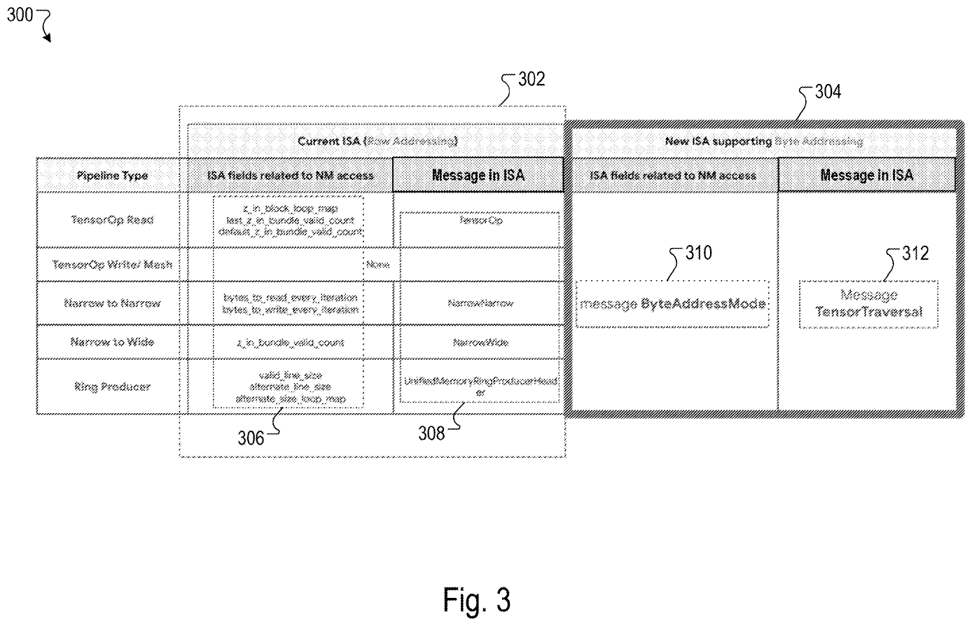

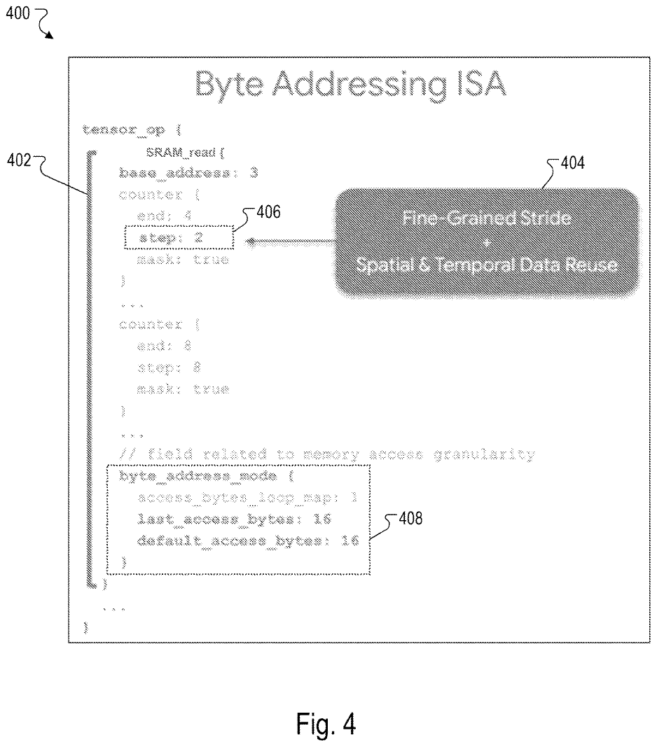

FIG. 3 shows example fields and message structures of example instruction sets. A first set of fields and message structures is associated with a first instruction set 302, whereas a second, different set of fields and message structures is associated with a second, different instruction set 304. Instruction set 302 represents a prior method for data access that was limited to row addressing schemes for accessing physical memory. For example, instruction set 302 can represent an existing instruction set that is deficient at least because it includes operations that require data padding and access alignment requirements, which are difficult to program and debug. This is described below with reference to the example of FIG. 4.

In the example of FIG. 3, instruction set 304 represents an ISA that allows for enhanced byte-level addressing functions to be performed against a memory (e.g., on-chip SRAM) of an example special-purpose processor. For example, the processor can be a TPU, a hardware accelerator, or neural net processor that uses a particular type of memory structure to store inputs for a compute operation such as a ML workload. As indicated above, the processor can include multiple compute tiles 101, where each compute tile 101 can be configured to perform some (or all) portions of a compute operation, such as an operation processing a batch of inputs through a layer of an artificial neural network.

An input in the batch can correspond to an image and pixels of that image can be represented as an input tensor (e.g., a multi-dimensional input tensor). Each pixel in the tensor of inputs can correspond to a neural network input that is provided as an input to a layer of a neural network. A neural network input can also be an activation value that corresponds to a neural network output that is generated as an output of a neural network layer. Each input (or activation) value of the tensor corresponds to an element along a particular dimension (e.g., X, Y dimension) of the multi-dimensional tensor. Relatedly, each element of a tensor can correspond to a memory location of memory 108 (or memory 110) and each memory location can have a corresponding address.

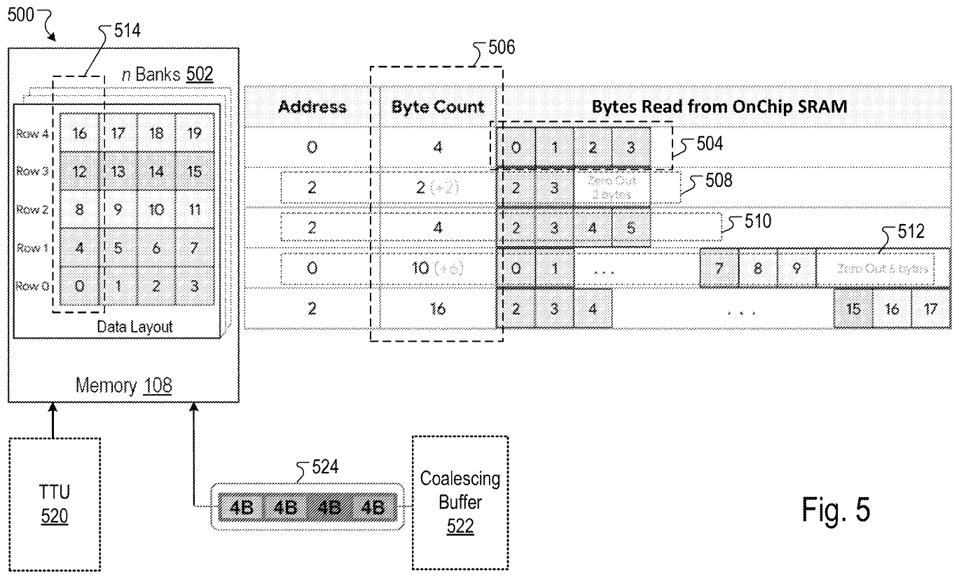

In some implementations, each compute tile 101 includes a respective tensor traversal unit (TTU) that generates addresses for traversing elements along a given dimension of a tensor. An example TTU is described below with reference to FIG. 5. Each input can be represented by a group of bits (e.g., a byte) that is stored at a given memory address location of memory 108. Using the disclosed instruction set 304, the system 100 can cause one or more of the TTUs to generate addresses at byte-level granularity. This is described in more detail below.

In general, an ISA 302, 304 can include data fields and corresponding messages that relate to those data fields. For example, a data field can specify an attribute or detail of an operation, whereas a message can indicate the type of operation. In the example of FIG. 3, ISA 302 requires multiple fields 306 and messages 308 for a given operation. For example, memory accesses using opcodes of ISA 302 often required multiple data fields, such as row information fields or hardware component fields, which often translates to increases in processing overhead at the compute tile.

In contrast, ISA 304 represents an improved instruction set that provides a streamlined approach for specifying attributes and type information for various memory access operations. For example, the integrated aspects of ISA 304 provide for a simplified and modular ISA that provides unified, semantically consistent fields to allow for diverse memory access patterns. Rather than relying on multiple information fields, the ISA 304 incorporates a unified information field 310 and a unified message field 312, which increases overall performance by avoiding the need to store and process values for extraneous fields and reducing data communications required to transmit those values.

In some implementations, opcodes generated by ISA 304 have an information field 310 that can include a byte count parameter that indicates a quantity of bytes to be accessed from a memory location of a compute tile 101. In some cases the information field 310 is included in an opcode to indicate that a byte address mode of a compute tile has been activated. For example, an opcode in an instruction sent to a compute tile can convey a “ByteAddress Mode” message that provides integrated fields for byte-level access to data in memory 108, 110. This is described in more detail below with reference to FIG. 4.

For ISA 304, the unified information field 310 and message field 312 cooperate to provide byte granularity addressing that enables accessing various lengths of contiguous bytes from any given byte address at a memory bank of a compute tile 101. In some implementations, a compute tile 101 can include one or more TTUs and ISA 304 is configured so that each TTU can have a matching ByteAddressMode field or instruction.

Message field 312 represents a streamlined approach for indicating a pipeline type (or type of operation) for which a byte-level access might occur. For example, the message field 312 can indicate tensor traversal for tensor read/write operations.

In some implementations, the message field 312 can indicate byte-level accesses for operations such as read or write access requests to: i) move data (e.g., parameters) from a first on-chip SRAM 108 to a second on-chip SRAM 110 and ii) move data from memory 110 to memory 108. One or more of these move operations can be used to support parameter caching. In some cases, to process an example workload, a first compute tile 101 arbitrates and executes access requests (e.g., read/write requests) for memory 108, where the requests are based on external data communications that originate from outside the first compute tile 101.

FIG. 4 shows example code for a tensor operation 400 that involves executing an input memory read operation (402) using a byte-addressing feature of the improved instruction set disclosed herein. In some implementations, the code for operation 400 corresponds to an instruction for a memory addressing technique performed to access data from a portion of on-chip SRAM that primarily stores inputs and activations for processing through a neural network later. The instruction (and/or code) for operation 400 may be derived from an ISA 304 for an example TPU that includes one or more compute tiles 101.

As noted above, existing ISAs (e.g., ISA 302) have data padding and access alignment requirements, and are difficult to program and debug. The alignment aspect relates to a requirement that, for a given access request, the number of bytes of data that are accessed must be a multiple of some particular integer value, where the integer value is greater than one (e.g., four). The data padding aspect corresponds to the alignment aspect and relates to the requirement of padding some number of bytes onto one or more bytes that are returned for a given request. The number of bytes that are padded onto the bytes that are returned is based on the integer multiple.

For example, an existing/prior instruction set may be tightly coupled to a micro-architecture of a circuit such that memory units of that circuit are required to return a minimum of four bytes even if a particular request only needs one, two, or three bytes of data. Thus, if a given request wants to access one byte and a prior instruction set imposes a four-byte requirement (i.e., integer value =4), then the padding and alignment constraint of this prior ISA would require three-byte padding. For this operation, an example compute tile 101 would be required to return four-bytes of data but the three padding bytes would then be discarded. In some implementations, such inefficient padding and alignment requirements are associated with row addressing schemes that impose unnecessary constraints on read accesses against memory 108, 110.

In contrast to existing/prior instruction set, the techniques and systems disclosed in this specification provide for new combinations of byte access patterns in support of ML computations. More specifically, the disclosed techniques support more flexible memory access patterns and do not restrict opportunities for diverse access patterns in new domains such as image processing. In some implementations, the improved instruction set and byte access techniques (e.g., ISA 304) are used to optimize stencil operations involving data reuse patterns. Such operations are strong candidates for exploiting data locality for certain image processing applications.

For example, referring again to tensor operation 400, the data access patterns allow for various types of fine-grained stride (404) operations for workloads such as ML image processing operations, as well as spatial and temporal data reuse (404) in support of ML inference and training workloads for a range of data science applications. In the example of FIG. 4, aspects of a stride operation can be controlled via “step” parameter 406. In general, a stride is processed in connection with memory accesses to obtain data such as image pixel values for an image processing ML workload.

The images, or pixel values associated with the images, can be stored across the physical rows and banks of memory 108, 110, with reference to a hardware configuration of the physical rows and banks of the memory. In this example, a stride is a component or parameter of a filter (or kernel) of the neural network. The stride is used to modify an amount that the filter moves over an image or video. For example, when the stride is set to 1, then compute tile 101 moves the filter(s) over the region one pixel (or input) at a time. Likewise, when the stride is 2, then compute tile 101 moves the filter(s) over the region two pixels at a time. Thus, filters may be shifted based on a stride value for a layer and, in some implementations, the system 100 can repeatedly perform this process across multiple compute tiles 101 for different layers until inputs for different regions of an image have a corresponding dot product.

Moving a filter over inputs of a region of an image based on a stride (or “step”) value can include retrieving, obtaining, or otherwise accessing the inputs from various locations in memory 108, 110 in accordance with that stride value. In the example of FIG. 4, the stride can be represented as a “step” size (e.g., step =2) that is used when sliding a convolutional filter over an input image. By enabling localized tile access to various lengths of contiguous bytes, the improved byte-addressing ISA (e.g., ISA 304) of this specification supports and allows for a range of strides (or step values) to be applied from any given byte address of an input memory at a compute tile.

As noted above, the improved ISA includes one or more ByteAddressingMode instructions with integrated fields related to memory access granularity and that allow for auto-zero padding when accessing data from an input memory of a compute tile. For example, the instruction byte_address_mode (408) can include one or more “access_bytes” fields for indicating a number of bytes to be written in an address space of memory 108, 110 at a given iteration. In some implementations, the bytes may be written to a contiguous address space, e.g., linear access, or a non-contiguous address space. The auto-zero padding can be implemented on the fly via hardware logic, software logic, or both.

Regarding the access_bytes fields, the instruction can include one or more fields such as access_bytes_loop_map, last_access_bytes, and default_access_bytes. A valid byte size for a given data packet can be indicated by a valid_byte_size field or parameter in a particular byte_address_mode instruction or message. In some implementations, a value for an access_bytes field in an instruction for byte-level access can be greater than a maximum valid bytes size per packet if consecutive packets deliver data to be stored in the contiguous address space. Thus, the access_bytes can be larger than the amount of data each ring/mesh packet carries.

In these examples, the hardware compute tile can consume these ring packets and contiguously writing the packets to a specified memory address. The packets can be consumed concurrent with determining how much, or which portion(s), of a particular packet is valid for consumption by the particular hardware unit. For example, there may be 20 incoming ring packets. Each packet carries 32B of data, where only 25B of the 32B are valid. In this example, access_bytes field/instruction can 500B/bytes for the ring bus consumer pipeline. Thus, ring consumer will consume all 20 ring packets, extract 25B from each, and a total 500 of these bytes will be written in a contiguous fashion at a starting address specified by the TTU.

Using the access_bytes_loop_map, the system 100 decides whether to access default_access_bytes or last_access_bytes. For each TTU iteration, the system reads these access bytes (e.g., default or last) depending on a particular access_bytes_loop_map. For each TTU clock cycle, a new start address may be generated to retrieve one or more access_bytes. In some implementations, the valid_byte_size is specific to a ring bus or mesh bus data packet. Each packet can include, for example, 32B of data, and a count value can be provided with the valid_byte_size field/instruction to specify portions of the 32B data packet that are valid for consumption by a particular tile(s).

In a byte addressing mode, one or more tiles of system 100 can dynamically create write transactions for byte-level accesses based on a valid_byte_size of a given packet and the outstanding access_bytes. In some implementations, control logic at a given tile 101 is configured to determine whether a single packet needs to be split into multiple write transactions and, in response to determining that the packet requires splitting, generate control signals to support or execute the splitting operation and generating the write transactions.

For example, the system 100 leverages this splitting feature to enable support for on-the-fly packet scattering, which allows for more efficient use of available bandwidth of bus 109. In some implementations, the write transactions can include multiple byte-level requests. In some cases, the byte-level requests correspond to byte addressing sequences.

Each address of the sequence identifies a memory location for storing (and later accessing) a byte of data, such as an input to be proceeded for a machine-learning workload.

As noted above, the bus 109-1 can be a ring bus that traverses two or more compute tiles to communicate datasets such as inputs and weights to the compute tiles for executing an ML workload. These datasets may be referred to alternatively as ring packets. For example, the datasets can be inbound ring packets that arrive at a compute tile 101 via a ring bus 109-1 of system 100. Inputs of a ring packet that are received at the compute tile 101 are stored in memory 108 before being accessed and routed to computational unit 112 for computations that are required to execute the ML workload.

The improved ISA and its corresponding byte_address_mode instruction allows input data in a ring packet to be managed at byte-level granularity. In contrast to row addressing schemes where data is written over several cycles due to padding and alignment requirements, the byte-level schemes enabled by the improved ISA provides a mechanism to store data, such as ring packets or caching of partial sums, at coarse granularity using fewer clock cycles and overall bandwidth.

For example, during an infeed operation a tile can receive a packet with 32 byte (32B) data from bus 109-1 (e.g., a ring bus). A structure of memory 108 may be limited to 4B per row, thus requiring an alignment across eight rows to receive the 32 bytes of data.

But in some cases, an example address of memory 108 that the data will be written to (e.g., 0x0 . . . 4) will not be aligned with eight rows. With a prior instruction set, such as ISA 302 or a related canonical approach, writing data to this unaligned address would require a system to first write the 32 bytes to an eight-row aligned address, using one cycle or more cycles. The system would then move the data back to the target address (i.e., 0x0 . . . 4) by using an example SRAM1-to-SRAMI operation, where data is moved within (or locally) at memory 108. Referencing the prior instruction set, the bandwidth of a SRAM1 -to-SRAM1 pipeline at a compute tile 101 can be 4 bytes (4B) per cycle. So, for prior instruction sets, an end-to-end cycle time for the infeed operation (ring-to-SRAM 1 write) would require at least 9 cycles, which is needlessly high.

The improved instruction set of ISA 304 allows for SRAM1 (or SRAM2) memory writes (e.g., at memory 108, 110) to any byte address without the extraneous overhead of additional cycles and bandwidth consumption. The system 100 can perform certain write operations with fewer clock cycles and without row-alignment constraint or additional operations that were required with prior instruction sets. The system 100 can use the configurations permitted by ISA 304 to execute a range of write operations in a single cycle, irrespective of how memory banks of memory 108, 110 are organized at a tile. For example, when a requested bundle size is 8 (e.g., 32 bytes), address sets generated by a TTU at the tile are not required to be eight-row aligned (e.g., 0, 8, 16 . . . row addresses) to finish writing the bundle in a single cycle.

Additionally, rather than discarding packets, the byte addressing mode of the improved ISA supports efficient byte granularity filtering of data packets received at a tile 101, such as in a ring consumer mode of bus 109. The system 100 is operable to disassociate packet boundaries from filtering and focus on the data itself without padding. One principle behind the byte granularity filtering is to configure a new ISA such that TTUs can be decoupled from the conventional packet boundary-based data processing schemes.

The byte addressing mode and filtering features of the improved ISA can use specific fields that allow the bus 109 to deliver valid bytes of data in linearized order. This allows tiles 101 to selectively filter in or out the byte stream when the tile consumes packets of inbound data. To support filtering and other byte granularity operations, an example byte address mode instruction of ISA 304 can include fields such as first_discard_byte_count, discard_byte_count (filter_out_bytes), access_bytes, and last_discard_byte_count. In some implementations, each tile can include a register and associated control logic that tracks the outstanding access_bytes that are initialized by access_bytes when an iteration starts. When a write transaction is generated, the register value decreases by the number of valid bytes in that transaction.

The byte granularity filtering features can be used in conjunction with a TTU of a compute tile 101 to support any arbitrary slicing of one or more tensors, such as slicing of elements along a particular dimension of the tensor. For example, the system 100 can leverage the filtering features to move slices of a tensor to different tiles, where the slicing could be done based on any chosen dimension. Furthermore, this can then be extended to any relayout change, where data associated with a tensor is stored in memory 108 (or 110) based on a first layout and then undergoes a re-layout to change the manner (or order) in which the data is stored in the tile memory.

FIG. 5 shows aspects of an example byte-addressing operation. This example operation can be associated with a read operation performed using a TTU of a compute tile 101.

In the example of FIG. 5, a partition of memory 108 includes n number of physical memory banks 502, where n is an integer greater than or equal to one. For example, a memory of compute tile 101 can include 32 physical memory banks 502, which may be identified as banks 0-31. Each bank can include some number of rows, e.g., 4, 16, 24, etc. Each row has a width that can be defined in bytes. For example, each row can be 16 bytes (16B) wide such that a compute tile 101 accesses data from memory 108 in 16B chunks (e.g., 128-bits). In some implementations, memory 108 can include more or fewer physical memory banks and each row of a bank can have a width that is more than 16B or less than 16B (e.g., 1B).

As noted above, prior instruction sets are limited by padding and alignment requirements that impose storage and bandwidth overhead, which eventually lead to adverse impacts on performance and power. In particular, these prior instruction sets can be linked to row addressing schemes that needlessly constrain memory access operations. In some implementations, for certain sizes and structures of memory, row addressing schemes can be limited to four-byte granularity when reading data from the memory.

In the implementation of FIG. 5, although the example rows of memory 108 are shown as being 4 bytes (4B) wide, the improved ISA of this specification allows a compute tile 101 to access data from tile memory in 1B, 2B, 3B, 4B, or greater than 4B chunks.

Control logic (e.g., a controller) of compute tile 101 can identify opcodes and data fields in an instruction to perform memory operations at one or more banks 502 of memory 108. The opcodes and data fields can be processed to generate an example byte addressing sequence 504 used to access different lengths of contiguous bytes that are stored at the one or more banks 502.

The instruction can include a “byte_count” 506 that field specifies a quantity of contiguous bytes to be fetched with reference to a starting address for a memory location of memory 108, 110. As shown at FIG. 5, an address can be indicated as “0” or “2.” A compute tile 101 can reference a particular starting address in a byte addressing sequence, and then perform multiple byte-addressable memory accesses at memory 108, 110 based on that starting address. The byte accesses can be performed as part of a tensor read operation to obtain input vectors from the one or more banks of memory 108.

In the example of FIG. 5, a read operation (508) is performed to obtain distinct/different portions of byte-level data stored at respective address locations of a bank 502 of memory 108. This particular read operation (508) is performed to obtain two bytes (byte count=2). The operation begins at address “2” in row0 of a memory bank 502 and includes obtaining a first byte-level data stored at address “2” and a second, different byte-level data stored at address “3.” In some implementations, the different portions or length of byte-level data is defined based on a byte count integer. In these implementations, a byte addressing sequence is used to access a plurality of contiguous bytes, the number of the plurality (e.g., the length) being variable (e.g., as defined by the instruction).

Another read operation (510) is performed to obtain distinct portions of byte-level data stored at respective address locations of a bank 502. This particular read operation (510) is performed to obtain four bytes (byte count=4). The operation begins at address “2” in row0 of a memory bank 502 and includes obtaining respective byte-level data stored at addresses 2 and 3 at row0 and addresses 4 and 5 at row1.

Another read operation (512) is performed to obtain distinct portions of byte-level data stored at respective address locations of a bank 502. This particular read operation (512) is performed to obtain 10 bytes (byte count=10). The operation begins at address “0” in row0 of a memory bank 502 and ends at address “9” in row2 of a memory bank 502. Thus, this particular read operation (512) includes obtaining respective byte-level data stored at addresses 0, 1, 2, 3, 4, 5, 6, 7, 8, and 9, where the address sequence spans row 0, row1, and row2.

The read operations 508, 510, 512 can be against the same memory bank 502 or different memory banks 502. Notably, a read or write operation can begin at any valid byte address and is not required to begin at a row-aligned address 514, such as address 4, 8, 12, or 16. As discussed above, the integrated fields of the improved ISA allow for auto-zero padding when accessing data from a memory 108, 110 of a compute tile. As an example, for read operations 508 and 512, the system 100 can automatically zero out one or more bytes based on the byte count being accessed for a given read operation.

Each compute tile 101 includes a TTU 520 that is used to perform access operations at tile memory. For the example read operations of FIG. 5, based on opcodes and data fields of the improved ISA, the TTU 520 is operable to generate addresses that can indicate any of one or more valid byte addresses. In particular, the streamlined configuration of the improved ISA and associated byte address mode allows the TTU 520 to generate addresses at a byte level granularity. The TTU 520 is also decoupled from the conventional packet boundary data processing.

The ISA 304 can be configured to provide explicit hints for contiguous data size and its synchronization timing. For example, the “access_bytes” field can be used to define the minimum synchronization granule, its corresponding timing, and an amount of contiguous data. The ISA 304 can enable certain software agnostic optimization, such as leveraging TTU byte-level addressing without the overhead of any TTU re-programming for a new instruction set. In some implementations, these characteristics of an improved ISA can be leveraged to simplify architecture designs regarding aspects such as synchronization, coherence, and tag matching.

In addition to the ISA, the compute tile 101 can include particular hardware features and configuration of data pipelines that enable the tile to operate more efficiently on data at those granularities. In some implementations, the compute tile 101 can include a coalescing buffer 522 that is used to increase SRAMI (e.g., narrow memory) write granularity when writing outputs of NLU 210 to memory 108. In some implementations, the system 100 can implement the new byte-addressing ISA in cooperation with the coalescing buffer 522 to perform on-the-fly gathering.

The byte-addressing ISA and coalescing buffer 522 can be used at a compute tile 101 to coalesce data from multiple packets, such that the coalesced data can be written in an example contiguous address space at once (e.g., concurrently). For example, based on the coalescing buffer 522, rather than writing data to memory 108 using multiple discrete 4B transactions, a set of data can be written as a single 16B write transaction (524), thereby saving on clock cycles for a particular write operation. The 16B value can be indicated via an access_bytes field of an instruction issued via the byte-addressing ISA.

Relative to prior approaches, this coalesce and write operation can increase the SRAMI memory bandwidth and provide a lower likelihood of experiencing bank conflicts at memory 108, 110. In some cases, the multiple packets from which data is coalesced can be data packets that are generated locally at a compute tile 101 or external, incoming data packets that are received at the compute tile via bus 109. In some implementations, this coalescing operation can be used to enhance NLU output granularity and bandwidth when writing output activations to memory 108. For example, this can allow for byte-level NLU output granularity.

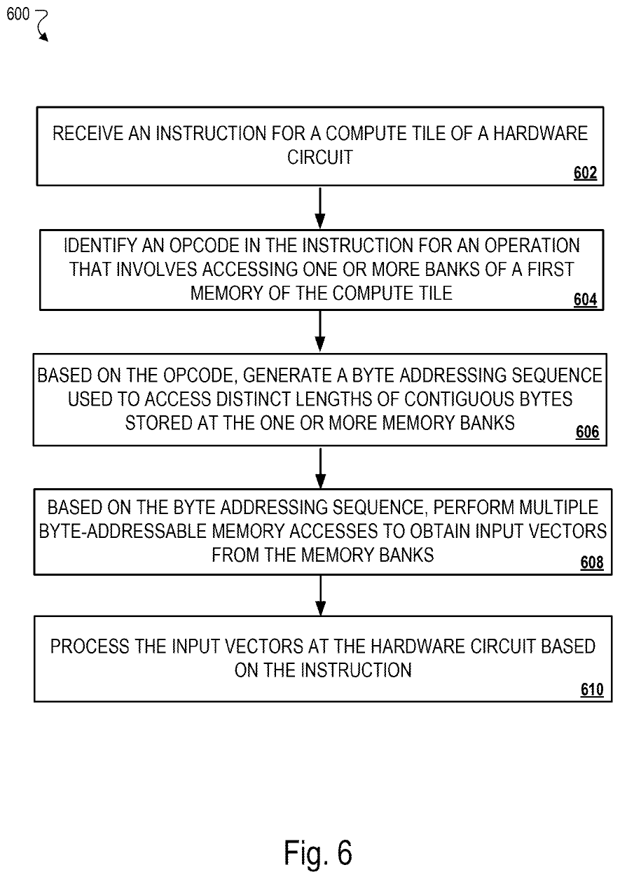

FIG. 6 is an example process 600 for byte stream processing using an example byte-addressing operation of an instruction set. Process 600 can be implemented or executed using the system 100 described above. Hence, descriptions of process 600 may reference the above-mentioned computing resources of system 100. In some examples, the steps or actions of process 600 are enabled by programmed firmware instructions, software instructions, or both. Each type of instruction may be stored in a non-transitory machine-readable storage device and is executable by one or more processors of the devices and resources described in this document, such as a compute tile of a hardware accelerator or neural network processor.

In some implementations, the steps of process 600 are performed at a hardware circuit to generate a layer output for a neural network layer. The output can be a portion of computation for a machine-learning task or inference workload to generate an image processing or image recognition output. As indicated above, the integrated circuit can be a special-purpose neural network processor or hardware machine-learning accelerator configured to accelerate computations for generating various types of data processing outputs.

Referring again to process 600, system 100 receives an instruction for a compute tile of a hardware circuit (602). The system 100 can identify an opcode in the instruction for an operation that involves accessing one or more banks of a first memory of the compute tile (604). For example, the instruction can be a byte address mode instruction that includes an opcode indicating a tensorop read operation or a tensor op write operation. In some implementations, either the instruction itself, or one or more opcodes of the instruction, includes a byte count field that indicates a quantity of bytes to be accessed from a memory location of a compute tile 101.

The system 100 can determine and/or generate a byte addressing sequence based on the opcode and any associated data fields of the instruction (606). The byte addressing sequence is used to access distinct lengths of contiguous bytes that are stored at one or more memory banks 502 of memory 108, 110. For example, the byte addressing sequence is operable to access the different lengths of contiguous bytes starting from any byte address at any row among multiple rows of a memory bank and at any bank among multiple memory banks of memory 108, 110. In some implementations, the byte addressing sequence can be generated by a TTU of a compute tile to obtain or store inputs of an input tensor or a parameter tensor. For example, each address of the byte addressing sequence identifies a memory location for reading (or writing) a byte of data. One or more bytes of data can represent an input or a vector of inputs for processing at a layer of a neural network.

Based on the byte addressing sequence, the system 100 can perform multiple byte-addressable memory accesses to obtain input vectors from the memory banks (608). For example, a compute tile 101 processes opcodes and parameter values of byte count fields (e.g., access_bytes) in the byte address mode instruction. In response to this processing, the compute tile 101 can generate one or more byte access requests based on a field or opcode of the instruction. Each byte access request provides byte-granularity access for at least one byte of data at any given address at any given row in a memory bank of the tile.

The byte access requests can be for write transactions, read transactions, or a combination of these. For example, byte access requests can be a write transaction that includes, or corresponds to, a byte address sequence. In some implementations, a byte access request can be a read transaction that incorporates auto-zero padding. An example byte address sequence for a read transaction can include a respective address for a memory location in tile memory that stores a distinct portion of byte-level data. Each address location can correspond to an element of an input tensor that is processed as part of a machine-learning workload. For example, each address location, along with the byte-level data stored at that location, can be mapped to a corresponding element of the input tensor.

As indicated above, the byte-level data can be an input or a vector of inputs and the system 100 can process the input vectors at the hardware circuit based on the instruction (610). For example, a compute tile 101 can generate an output for a neural network layer in response to processing the input vectors through the neural network layer. This processing can involve arithmetic operations performed at a computational unit 112. The arithmetic operations can yield sets of outputs that are written to (stored at) memory 108. The outputs can be activation values that are written to memory 108 using byte-addressable memory accesses. These byte-level accesses can be performed based on an opcode in the byte address mode instruction. For example, the opcode can indicate a tensorop write transaction that involves a TTU 520 of a compute tile 101 and a coalescing buffer 522 coupled to memory 108 at the tile.

FIG. 7 illustrates examples of tensors or multi-dimensional matrices 700 that include an input tensor 704, variations of a parameter tensor 706, and an output tensor 708.

In the example of FIG. 7, each of the tensors 700 include respective elements, where each element can correspond to a respective value of data (or operand) for computations performed at a given layer of a neural network. As indicated above, the data or operands can be inputs, activations, weights (or parameters) for a compute operation involving one or more neural network layers or other types of ML constructs that are implemented at the compute tile 101.

For example, each input of input tensor 704 can correspond to a respective element along a given dimension of input tensor 704, each weight of parameter tensor 706 can correspond to a respective element along a given dimension of the parameter tensor 706, and each output value or activation in a set of outputs can correspond to a respective element along a given dimension of output tensor 708. Relatedly, each element can correspond to a respective memory location or address in a memory of a compute tile 101 that is assigned to operate on one or more dimensions of a given tensor 704, 706, 708.

The computations performed at a given neural network layer can include multiplication of an input/activation tensor 704 with a parameter/weight tensor 706 on one or more processor clock cycles to produce layer outputs, which may include output activations. Multiplying an activation tensor 704 with a weight tensor 706 includes multiplying an activation from an element of tensor 704 with a weight from an element of tensor 706 to produce one or more partial sums. The example tensors 706 of FIG. 7 can be unmodified parameter tensors, modified parameter tensors, or combination of these. In some implementations, each parameter tensor 706 corresponds to a modified parameter tensor that includes non-zero CSP values that are derived based on the sparsity exploitation techniques described above.

The processor cores of system 100 can operate on: i) scalars that correspond to a discrete element in some multi-dimensional tensor 704, 706; ii) a vector of values (e.g., input vector 102) that include multiple discrete elements 707 along the same or different dimensions of some multi-dimensional tensor 704, 706; or iii) a combination of these. The discrete element 707, or each of the multiple discrete elements 707, in some multi-dimensional tensor can be represented using X, Y coordinates (2D) or using X, Y, Z coordinates (3D) depending on the dimensionality of the tensor.

The system 100 can compute multiple partial sums that correspond to products generated from multiplying a batch of inputs with corresponding weight values. As noted above, the system 100 can perform an accumulation of products (e.g., partial sums) over many clock cycles. For example, the accumulation of products can be performed in a random access memory, shared memory, or scratchpad memory (e.g., memory 108) of one or more compute tiles 101 based on the techniques described in this document. In some implementations, the accumulation of products to memory of a compute tile is performed using a byte addressing mode instruction of ISA 304.

In some implementations, an input-weight multiplication may be written as a sum-of-product of each weight element multiplied with discrete inputs of an input vector 102, such as a row or slice of the input tensor 704. This row or slice can represent a given dimension, such as a first dimension 710 of the input tensor 704 or a second, different dimension 715 of the input tensor 704. The byte granularity filtering features of the improved ISA 304 can be used to support the multiplication operations, including any arbitrary slicing of one or more tensors, such as slicing of elements along a particular dimension of the tensor.

In some implementations, an example set of computations can be used to compute an output for a convolutional neural network layer. The computations for the CNN layer can involve performing a 2D spatial convolution between a 3D input tensor 704 and at least one 3D filter (weight tensor 706). For example, convolving one 3D filter 706 over the 3D input tensor 704 can produce a 2D spatial plane 720 or 725. The computations can involve computing sums of dot products for a particular dimension of an input volume that includes the input vector 102.

For example, the spatial plane 720 can include output values for sums of products computed from inputs along dimension 710, whereas the spatial plane 725 can include output values for sums of products computed from inputs along dimension 715. The computations to generate the sums of the products for the output values in each of spatial planes 720 and 725 can be performed: i) at the compute cells 114 a/b/c, ii) directly at the memory 110 using an arithmetic operator coupled to a shared bank of the memory 110, iii) or both. In some implementations, reduction operations may be streamlined and performed directly at a memory cell (or location) of memory 110 using various techniques for reduction of accumulated values.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network.

Examples of communication networks include a local area network (“LAN”) and a wide area network (“WAN”), e.g., the Internet.

The computing system can include clients and servers. A client and server are generally remote from each other and typically interact through a communication network.

The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

In the following section, additional examples are provided:

Example 1: A computer-implemented method for accessing memory banks of a hardware accelerator, the method comprising: receiving an instruction for a compute tile of the hardware accelerator, the instruction being executable at the compute tile to cause performance of operations comprising: identifying, in the instruction, an opcode for an operation that involves accessing one or more banks of a first memory of the compute tile; generating, based on the opcode, a byte addressing sequence used to access different lengths of contiguous bytes stored at the one or more banks; based on the byte addressing sequence, performing, at the first memory, a plurality of byte-addressable memory accesses to obtain a plurality of input vectors from the one or more banks of the first memory; and processing, based on the instruction, the plurality of input vectors at the hardware accelerator.

Example 2: The method of example 1, wherein the byte addressing sequence is operable to access the different lengths of contiguous bytes starting from any given byte address across the one or more banks of the first memory.

Example 3: The method of example 1 or 2, further comprising: generating, based on the opcode, a byte access request that provides byte-granularity access for obtaining at least one byte of data stored at a given row of a bank among the one or more banks of the first memory.

Example 4: The method of any preceding example, where generating the byte addressing sequence comprises: generating a byte addressing sequence corresponding to a plurality of byte access requests, each byte access request being used to access distinct portions of byte-level data stored at respective address locations across the one or more banks of the first memory.

Example 5: The method of any preceding example, wherein the opcode is for a tensor operation that is executed at the compute tile to traverse respective elements of an input tensor.

Example 6: The method of example 5, as dependent upon example 4, further comprising: executing the plurality of byte access requests using the byte addressing sequence; performing a plurality of byte-granularity accesses at the first memory based on the plurality of byte access requests that are executed; and traversing respective elements of the input tensor by performing the plurality of byte-granularity accesses at the first memory.

Example 7: The method of example 6, or example 5 as dependent upon example 4, wherein: each distinct portion of byte-level data that is stored at a respective address location across the one or more banks of the first memory corresponds to a respective element of the input tensor; and each respective address location that stores a distinct portion of byte-level data is mapped to a corresponding element of the input tensor.

Example 8: The method of example 6 or example 7 as dependent upon example 6, wherein: a portion of byte-level data corresponds to an input vector of the plurality of input vectors; and the plurality of byte-addressable memory accesses that are used to obtain a plurality of input vectors correspond to at least one of: i) the plurality of byte-granularity accesses and ii) the plurality of byte access requests.

Example 9: The method of any preceding example, wherein processing the plurality of input vectors comprises: processing the plurality of input vectors through a neural network layer of a neural network implemented at the hardware accelerator; and generating an output for the neural network layer in response to processing the plurality of input vectors through the neural network layer.

Example 10: A system comprising a hardware accelerator; a processing device; and a non-transitory machine-readable storage medium for storing instructions used to access memory banks of a hardware accelerator, the instructions being executable by the processing device to cause performance of operations comprising: receiving an instruction for a compute tile of the hardware accelerator, the instruction being executable at the compute tile to cause performance of operations comprising: identifying, in the instruction, an opcode for an operation that involves accessing one or more banks of a first memory of the compute tile; generating, based on the opcode, a byte addressing sequence used to access different lengths of contiguous bytes stored at the one or more banks; based on the byte addressing sequence, performing, at the first memory, a plurality of byte-addressable memory accesses to obtain a plurality of input vectors from the one or more banks of the first memory; and processing, based on the instruction, the plurality of input vectors at the hardware accelerator.

Example 11: The system of example 10, wherein the byte addressing sequence is operable to access the different lengths of contiguous bytes starting from any given byte address across the one or more banks of the first memory.

Example 12: The system of example 11, wherein the operations further comprise: generating, based on the opcode, a byte access request that provides byte-granularity access for obtaining at least one byte of data stored at a given row of a bank among the one or more banks of the first memory.

Example 13: The system of example 11 or 12, where generating the byte addressing sequence comprises: generating a byte addressing sequence corresponding to a plurality of byte access requests, each byte access request being used to access distinct portions of byte-level data stored at respective address locations across the one or more banks of the first memory.

Example 14: The system of any one of examples 10 to 13, wherein the opcode is for a tensor operation that is executed at the compute tile to traverse respective elements of an input tensor.

Example 15: The system of example 14 as dependent upon example 13, wherein the operations further comprise: executing the plurality of byte access requests using the byte addressing sequence; performing a plurality of byte-granularity accesses at the first memory based on the plurality of byte access requests that are executed; and traversing respective elements of the input tensor by performing the plurality of byte-granularity accesses at the first memory.

Example 16: The system of example 15, or example 14 as dependent upon example 13, wherein: each distinct portion of byte-level data that is stored at a respective address location across the one or more banks of the first memory corresponds to a respective element of the input tensor; and each respective address location that stores a distinct portion of byte-level data is mapped to a corresponding element of the input tensor.

Example 17: The system of example 15 or example 16 as dependent upon example 15, wherein: a portion of byte-level data corresponds to an input vector of the plurality of input vectors; and the plurality of byte-addressable memory accesses that are used to obtain a plurality of input vectors correspond to at least one of: i) the plurality of byte-granularity accesses and ii) the plurality of byte access requests.

Example 18: The system of any one of examples 10 to 17, wherein processing the plurality of input vectors comprises: processing the plurality of input vectors through a neural network layer of a neural network implemented at the hardware accelerator; and generating an output for the neural network layer in response to processing the plurality of input vectors through the neural network layer.

Example 19: A non-transitory machine-readable storage medium for storing instructions used to access memory banks of a hardware accelerator, the instructions being executable by a processing device to cause performance of operations comprising: receiving an instruction for a compute tile of the hardware accelerator, the instruction being executable at the compute tile to cause performance of operations comprising: identifying, in the instruction, an opcode for an operation that involves accessing one or more banks of a first memory of the compute tile; generating, based on the opcode, a byte addressing sequence used to access different lengths of contiguous bytes stored at the one or more banks; based on the byte addressing sequence, performing, at the first memory, a plurality of byte-addressable memory accesses to obtain a plurality of input vectors from the one or more banks of the first memory; and processing, based on the instruction, the plurality of input vectors at the hardware accelerator.

Example 20: The non-transitory machine-readable storage medium of example 19, wherein: the byte addressing sequence is operable to access the different lengths of contiguous bytes starting from any given byte address across the one or more banks of the first memory; and the operations further comprise: generating, based on the opcode, a byte access request that provides byte-granularity access for obtaining at least one byte of data stored at a given row of a bank among the one or more banks of the first memory.

1. A computer-implemented method for accessing memory banks of a hardware accelerator, the method comprising:
receiving an instruction for a compute tile of the hardware accelerator, the instruction being executable at the compute tile to cause performance of operations comprising:
identifying, in the instruction, an opcode for an operation that involves accessing one or more banks of a first memory of the compute tile;
generating, based on the opcode, a byte addressing sequence used to access different lengths of contiguous bytes stored at the one or more banks;
based on the byte addressing sequence, performing, at the first memory, a plurality of byte-addressable memory accesses to obtain a plurality of input vectors from the one or more banks of the first memory; and
processing, based on the instruction, the plurality of input vectors at the hardware accelerator.

2. The method of claim 1, wherein the byte addressing sequence is operable to access the different lengths of contiguous bytes starting from any given byte address across the one or more banks of the first memory.

3. The method of claim 1, further comprising:
generating, based on the opcode, a byte access request that provides byte-granularity access for obtaining at least one byte of data stored at a given row of a bank among the one or more banks of the first memory.

4. The method of claim 1, where generating the byte addressing sequence comprises:
generating a byte addressing sequence corresponding to a plurality of byte access requests, each byte access request being used to access one or more distinct portions of byte-level data stored at a respective address location across the one or more banks of the first memory.

5. The method of claim 4, wherein the opcode is for a tensor operation that is executed at the compute tile to traverse respective elements of an input tensor.

6. The method of claim 5, comprising:
executing the plurality of byte access requests using the byte addressing sequence;
performing a plurality of byte-granularity accesses at the first memory based on the plurality of byte access requests that are executed; and
traversing respective elements of the input tensor by performing the plurality of byte-granularity accesses at the first memory.

7. The method of claim 6, wherein:
each distinct portion of byte-level data that is stored at a respective address location across the one or more banks of the first memory corresponds to a respective element of the input tensor; and
each respective address location that stores a distinct portion of byte-level data is mapped to a corresponding element of the input tensor.

8. The method of claim 7, wherein:
a portion of byte-level data corresponds to an input vector of the plurality of input vectors; and
the plurality of byte-addressable memory accesses that are used to obtain a plurality of input vectors correspond to at least one of: i) the plurality of byte-granularity accesses and ii) the plurality of byte access requests.

9. The method of claim 1, wherein processing the plurality of input vectors comprises:
processing the plurality of input vectors through a neural network layer of a neural network implemented at the hardware accelerator; and
generating an output for the neural network layer in response to processing the plurality of input vectors through the neural network layer.

10. A system comprising a hardware accelerator; a processing device; and
a non-transitory machine-readable storage medium for storing instructions used to access memory banks of a hardware accelerator, the instructions being executable by the processing device to cause performance of operations comprising:
receiving an instruction for a compute tile of the hardware accelerator, the instruction being executable at the compute tile to cause performance of operations comprising:
identifying, in the instruction, an opcode for an operation that involves accessing one or more banks of a first memory of the compute tile;
generating, based on the opcode, a byte addressing sequence used to access different lengths of contiguous bytes stored at the one or more banks;
based on the byte addressing sequence, performing, at the first memory, a plurality of byte-addressable memory accesses to obtain a plurality of input vectors from the one or more banks of the first memory; and
processing, based on the instruction, the plurality of input vectors at the hardware accelerator.

11. The system of claim 10, wherein the byte addressing sequence is operable to access the different lengths of contiguous bytes starting from any given byte address across the one or more banks of the first memory.

12. The system of claim 11, wherein the operations further comprise:
generating, based on the opcode, a byte access request that provides byte-granularity access for obtaining at least one byte of data stored at a given row of a bank among the one or more banks of the first memory.

13. The system of claim 11, wherein generating the byte addressing sequence comprises:
generating a byte addressing sequence corresponding to a plurality of byte access requests, each byte access request being used to access distinct portions of byte-level data stored at respective address locations across the one or more banks of the first memory.

14. The system of claim 13, wherein the opcode is for a tensor operation that is executed at the compute tile to traverse respective elements of an input tensor.

15. The system of claim 14, wherein the operations further comprise:
executing the plurality of byte access requests using the byte addressing sequence;
performing a plurality of byte-granularity accesses at the first memory based on the plurality of byte access requests that are executed; and
traversing respective elements of the input tensor by performing the plurality of byte-granularity accesses at the first memory.

16. The system of claim 15, wherein:
each distinct portion of byte-level data that is stored at a respective address location across the one or more banks of the first memory corresponds to a respective element of the input tensor; and
each respective address location that stores a distinct portion of byte-level data is mapped to a corresponding element of the input tensor.

17. The system of claim 16, wherein:
a portion of byte-level data corresponds to an input vector of the plurality of input vectors; and
the plurality of byte-addressable memory accesses that are used to obtain a plurality of input vectors correspond to at least one of: i) the plurality of byte-granularity accesses and ii) the plurality of byte access requests.

18. The system of claim 10, wherein processing the plurality of input vectors comprises:
processing the plurality of input vectors through a neural network layer of a neural network implemented at the hardware accelerator; and
generating an output for the neural network layer in response to processing the plurality of input vectors through the neural network layer.

19. A non-transitory machine-readable storage medium for storing instructions used to access memory banks of a hardware accelerator, the instructions being executable by a processing device to cause performance of operations comprising:
receiving an instruction for a compute tile of the hardware accelerator, the instruction being executable at the compute tile to cause performance of operations comprising:
identifying, in the instruction, an opcode for an operation that involves accessing one or more banks of a first memory of the compute tile;
generating, based on the opcode, a byte addressing sequence used to access different lengths of contiguous bytes stored at the one or more banks;
based on the byte addressing sequence, performing, at the first memory, a plurality of byte-addressable memory accesses to obtain a plurality of input vectors from the one or more banks of the first memory; and
processing, based on the instruction, the plurality of input vectors at the hardware accelerator.

20. The non-transitory machine-readable storage medium of claim 19, wherein:
the byte addressing sequence is operable to access the different lengths of contiguous bytes starting from any given byte address across the one or more banks of the first memory; and
the operations further comprise:
generating, based on the opcode, a byte access request that provides byte-granularity access for obtaining at least one byte of data stored at a given row of a bank among the one or more banks of the first memory.
